(19) United States
(12) Patent Application Publication
(10) Pub. No.: US 2009/0083475 A1
(43) Pub. Date: Mar. 26, 2009

(54) APPARATUS AND METHOD FOR UPDATING FIRMWARE STORED IN A MEMORY

(75) Inventors: Jung-Lee Hsiao, Hsinchu County (TW); Ying-Chu Chen, Hsinchu City (TW); Jih-Liang Juang, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/859,849

(22) Filed: Sep. 24, 2007

(51) Int. Cl. G06F 12/02

(52) U.S. Cl. 711/103; 711/E12.008

(57) ABSTRACT

The invention provides a method for updating firmware stored in a memory. In one embodiment, the memory is divided into a plurality of blocks, and the firmware to be updated with a new image version. First, a first data block is obtained from the new image version, and a second data block is obtained from a target block selected from the memory. Whether the first data block is different from the second data block is then checked. The first data block is then written into the target block when the first data block is different from the second data block. Finally, the aforementioned steps are repeated until all of the blocks are processed.

### BACKGROUND OF THE INVENTION

1. Field of the Invention

The invention relates to firmware, and more particularly to the methods for updating firmware stored in a memory.

2. Description of the Related Art

A memory, a non-volatile computer memory, can be electrically erased and reprogranmmed memory technology is primarily used in memory cards and USB drives, such as thumb drives, handy drives, and memory sticks. Because memory is far less expensive than EEPROM, memory has become the dominant technology wherever a significant amount of non-volatile, solid-state storage is needed.

Electronic devices with controllers often comprise memories storing firmware operating the controllers. When an electronic device is modified with new functions, the firmware stored in the memory of the electronic device must be updated. The required capacity of a memory in the electronic devices increases with greater complexity. The larger the firmware, the longer the updating time is required. Thus, improved firmware update efficiency is highly desirable.

A memory is divided, erased and programmed by the operation of multiple blocks. FIG. 1 is a flowchart of a conventional method 100 for updating firmware stored in a memory. The variable N indicating a target block of the memory is initialized to 1 in step 102. Thus, the first block of the memory is selected as the target block. The variable M is set to be a maximum block number of memory in step 104. The variable N is then compared with the variable M in step 106. If the variable N is less than the variable M, not all of the memory blocks are completely updated. Thus, the target block, the Nth block of the memory is erased in step 108 and a new image version of the firmware is written to the target block in step 110. After finish the step 110 to write new data to the current target block, the variable N is increased in step 112 to select the next block as the target block. The variable N is then compared again with the variable M in step 106. If the variable N is less than the variable M, steps 108 to 112 are repeated again for processing another block of the memory. If the variable N is greater than the variable M, all of the memory blocks have been completely updated, and the method 100 ends.

The conventional method 100 erases and programs all blocks of a memory regardless of whether all the blocks require updating or not. Thus, all of the memory blocks are processed and the time required by the updating process is proportional to the size of the memory. The current firmware, however, may only be slightly different from the new firmware data. If only the block storing firmware data different from a corresponding data portion of the new image version needs to be updated, the time required by the updating process is greatly reduced. For example, if a memory comprises M blocks and only X blocks requires updating, the required updating time is reduced by a proportion of (M−X)/M. Thus, a method for updating firmware stored in a memory at higher speed is desirable.

### BRIEF SUMMARY OF THE INVENTION

The invention provides a method for updating firmware stored in a memory. In one embodiment, the memory is divided into a plurality of blocks, and the firmware to be updated with a new image version. First, a first data block is obtained from the new image version, and a second data block is obtained from a target block selected from the memory. Whether the first data block is different from the second data block is then checked. The first data block is then written into the target block when the first data block is different from the second data block. Finally, the aforementioned steps are repeated until all of the blocks are processed.

The invention also provides another method for updating firmware stored in a memory. In one embodiment, the memory is divided into a plurality of blocks, and the firmware to be updated with a new image version. First, a first signature of a first data block is obtained from the new image version, and a second signature of a second data block is obtained from a target block selected from the memory, wherein the first signature characterizes the first data block and the second signature characterizes the second data block. Whether the second signature is different from the first signature is then checked. The first data block is then written into the target block when the first signature is different from the second signature. Finally, the aforementioned steps are repeated until all of the blocks are processed.

The invention also provides another method for updating firmware stored in a memory. In one embodiment, the memory is divided into a plurality of blocks, and the firmware to be updated with a new image version, the method comprising. First, a target block selected from the blocks is erased. A data block is then obtained from the new image version for updating the target block. Whether the data block is completely composed of the hexadecimal digits “0xFF” is then checked. The data block is then written into the target block when the data block comprises hexadecimal digits different from “0xFF”. Finally, the aforementioned steps are repeated until all of the blocks are processed.

The invention also provides a firmware updating apparatus. In one embodiment, the firmware updating apparatus comprises a memory and a controller. The memory is divided into a plurality of blocks and stores firmware to be updated with a new image version. The controller updates only the blocks storing data different from a corresponding data portion of the new image version.

The invention also provides another firmware updating apparatus. In one embodiment, the firmware updating apparatus comprises a memory and a controller. The memory is divided into a plurality of blocks and stores firmware to be updated with a new image version. The controller erases the memory by checking whether a corresponding data portion is completely composed of the hexadecimal digits “0xFF”.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of a conventional method for updating firmware stored in a memory;

FIG. 2A is a flowchart of a method for updating firmware stored in a memory according to the invention;

FIG. 2B is a flowchart of a method for updating firmware by comparing data block signatures according to the invention;

FIG. 3 is a flowchart of a method for updating firmware by detecting whether written data is 0xFF;

FIG. 4A is a flowchart of another method for updating a firmware stored in a memory according to the invention;

FIG. 4B is a flowchart of still another method for updating a firmware stored in a memory according to the invention; and

FIG. 5 is a block diagram of a firmware updating apparatus according to the invention.

### DETAILED DESCRIPTION OF THE INVENTION

The following description is the best-contemplated mode of carrying out the invention. This description is made for the purpose of illustrating the general principles of the invention and should not be taken in a limiting sense. The scope of the invention is best determined by reference to the appended claims.

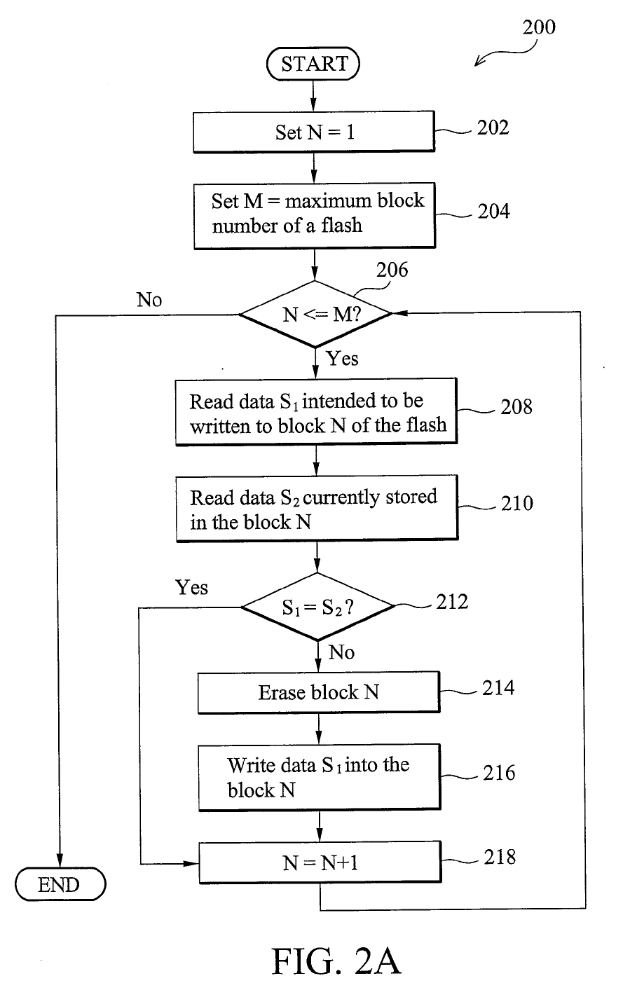

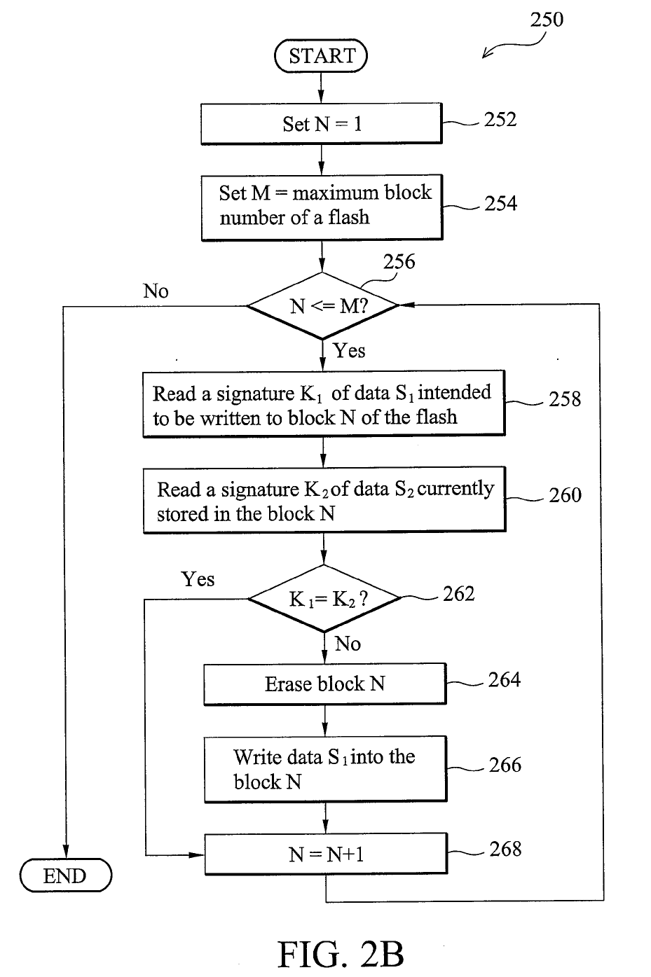

FIG. 2A is a flowchart of a method 200 for updating firmware stored in a memory according to the invention. The memory storing the firmware is divided into multiple blocks. The method 200 can be implemented by an apparatus having a controller to update firmware. The apparatus updates firmware stored in a memory with a new image version. In an embodiment, the apparatus is a device capable of updating firmware thereof, such as an optical disk drive or a handheld device. In another embodiment, the apparatus is a PC to update the firmware of other devices.

The controller first initializes a variable N to 1 in step 202, wherein the variable N indicates a target block of the memory. Thus, the first block of the memory is selected as the target block. In step 204 the controller sets a variable M to a maximum number of memory blocks. Then, in step 206, the controller compares the variable N with the variable M. If the variable N is less than the variable M, the controller has not completely updated all of the memory blocks, and the firmware update continues. The controller then reads the new image version in step 208 to obtain a data block S₁ for updating the target block. To compare the data block S₁ with the data content of the target block, the controller reads the target block (the Nth block of the memory) in step 2 10 to obtain a data block S₂ stored in the target block.

The controller then compares the data block S₁ of the new image version with the data block S₂ stored in the target block of the memory in step 212. If the data block S₁ is different from the data block S₂, the controller erases the target block in step 214, and writes the data block S₁ of the new image version into the target block of the memory in step 216. Otherwise, if the data block S₁ is identical to the data block S₂, the target block requires no update, and the controller skips writing the target block. After firmware update of the target block is complete, the controller increases the variable N by one in step 218. Thus, a next block of the current target block is selected as a new target block. The controller then executes steps 206 to 218 again for firmware update of the new target block. The steps 206 to 218 are repeated over different blocks of the memory until the variable N is greater than the variable M in step 206. At this time, all of the memory blocks have been completely updated according to the method 200.

Although time required for firmware updating is reduced by method 200, the controller must read all the bits of all the data blocks S₁ and S₂ in steps 208 and 210 to compare all corresponding bits of the data block S₁ and S₂ in step 212. Reading the entire data block is a time-consuming task. Thus, a signature of a data block can be generated according to content characteristics of the data block and written to a corresponding block of the memory in advance when the firmware is previously written to the memory. The signature can be a checksum or a version serial number of the corresponding data block to indicate whether the data block has changed.

FIG. 2B is a flowchart of a method 250 for updating firmware by comparing data block signatures according to the invention. The method 250 of FIG. 2B is similar to the method 200 of FIG. 2A, with the exception of steps 258, 260, and 262. Because data block signatures characterize the data block contents, a controller of a firmware update apparatus directly reads a signature K₁ of a data block S₁ to update the firmware in step 258. The controller also directly reads a signature K₂ of a data block S₂ stored in the target block of the memory in step 260. Because a signature comprises only a few bits, reading signatures in steps 258 and 260 of method 250 requires less time than reading entire data blocks as in steps 208 and 210 of method 200. When the controller wants to determine whether data block S₁ stored in the target block of the memory is different from a corresponding data block S₂ of a new image version, instead of comparing the entire blocks S₁ and S₂, the controller merely compares the signature K₁ of the data block S₁ with the signature K₂ of the data block S₂ in step 262. Thus, the time required by the method 250 for firmware updating is further reduced in comparison with the method 200 of FIG. 2A.

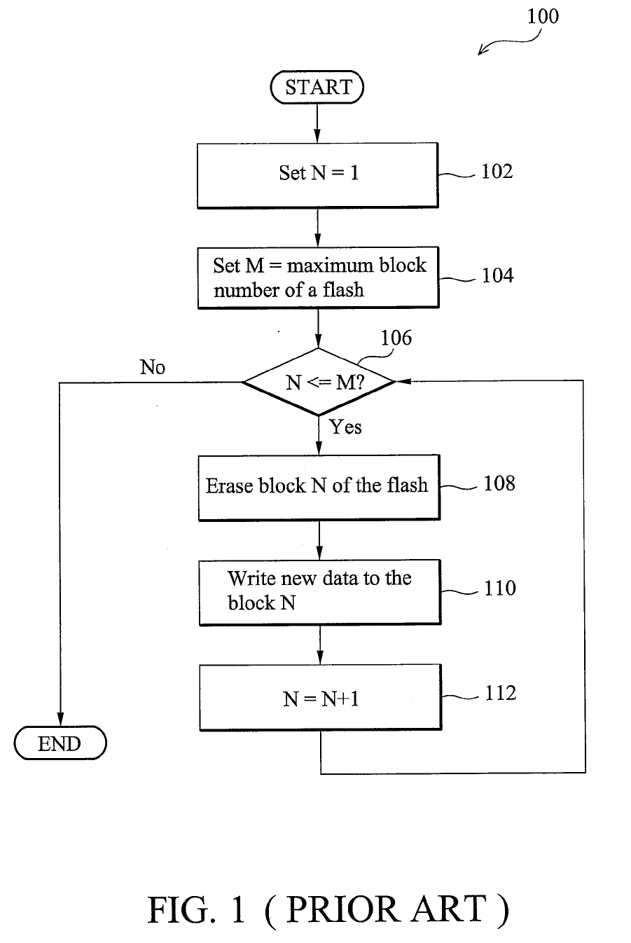

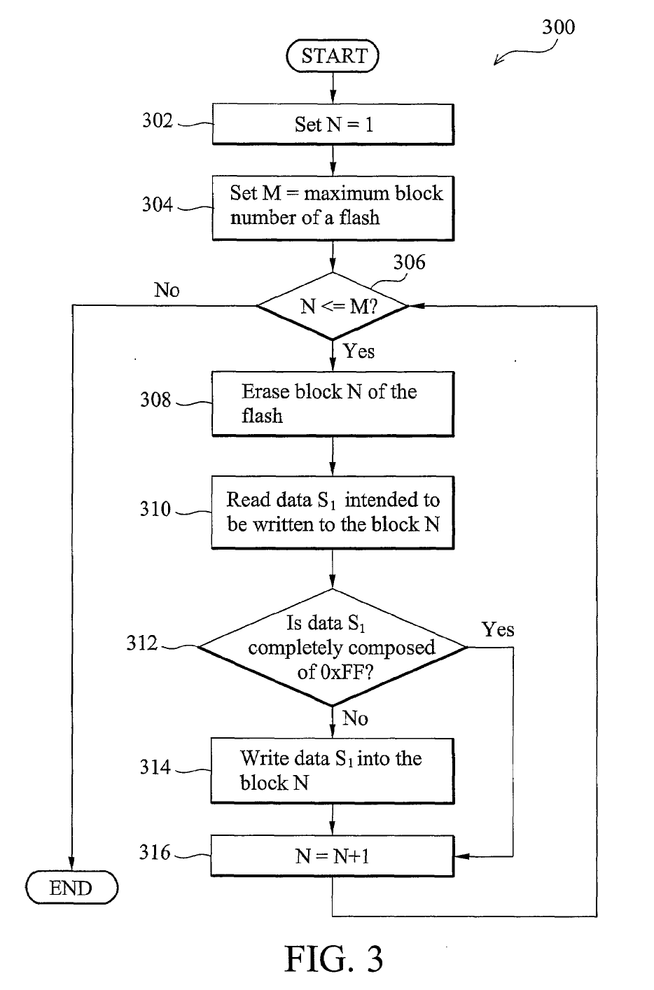

After a block of a memory is erased (such as the step 214 in FIG. 2A and the step 264 in FIG. 2B), all the data stored in the block is converted to hexadecimal digits “0xFF” to indicate that no data is stored therein. In conventional method such as the method 100 of FIG. 1, when firmware stored in a memory is updated, a controller, however, writes data to all the blocks of a memory. The size of the memory is greater than the size of the new image version. However, the controller still keeps writing a hexadecimal digit “0xFF” to remaining blocks of the memory after the new image version has been completely written into the memory. Time required for the firmware update is therefore increased. Thus, a method showed in FIG. 3 is provided to ameliorate this defect. FIG. 3 is a flowchart of a method 300 for updating firmware by detecting whether written data is 0xFF.

First, a controller of the apparatus initializes a variable N to 1 in step 302, wherein the variable N indicates a target block of the memory. The controller then sets a variable M to a maximum number of memory blocks in step 304. The controller then compares the variable N with the variable M in step 306. If the variable N is less than the variable M, the controller has not completely updated all of the memory blocks, and the firmware update continues. The controller then erases the target block in step 308 and reads the new image version in step 310 to obtain a data block S₁ for updating the target block. The controller than detects whether the data block S1 is completely composed of “0xFF” in step 312.

If the data block S₁ is not completely composed of 0xFF, the controller directly writes the data block S₁ into the target block in step 314. Otherwise, if the new image version has been completely written into the memory, no data can be read from the new image version in step 308 and the obtained: data block S₁ is filled with 0xFF. Because the target block has been erased in step 308, the content of the target block is 0xFF and does not need to write the content to the target block again. Thus, the controller skips writing the target block. After firmware update of the target block is complete, the controller increases the variable N by one in step 316: Thus, a next block of the current target block is selected as a new target block. Steps 306 to 316 are then repeated for different blocks of the memory until the variable N is greater than the variable M in step 306. At this time, all of the memory blocks have been completely updated according to the method 300.

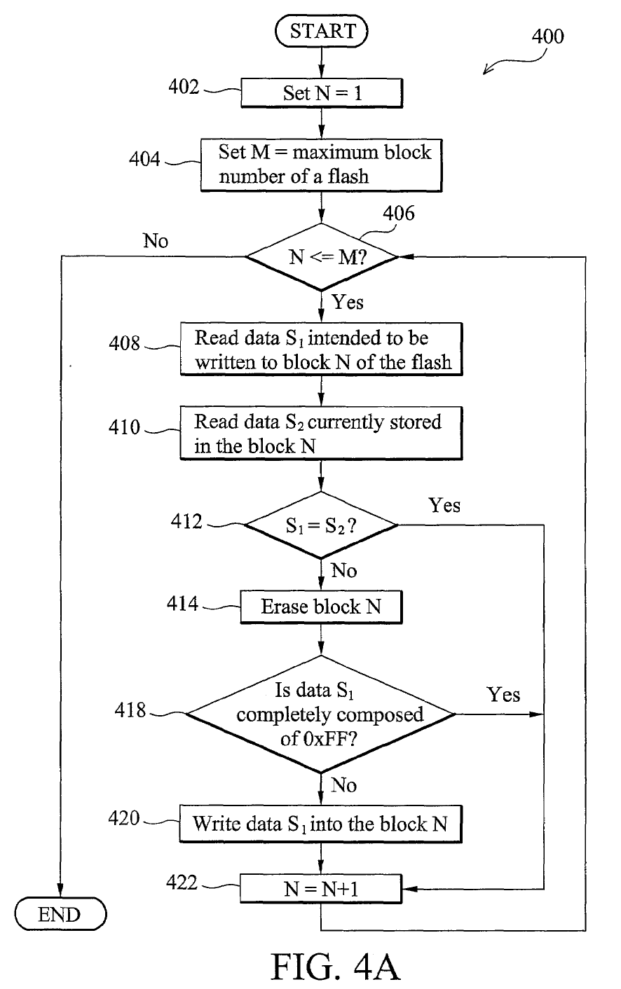

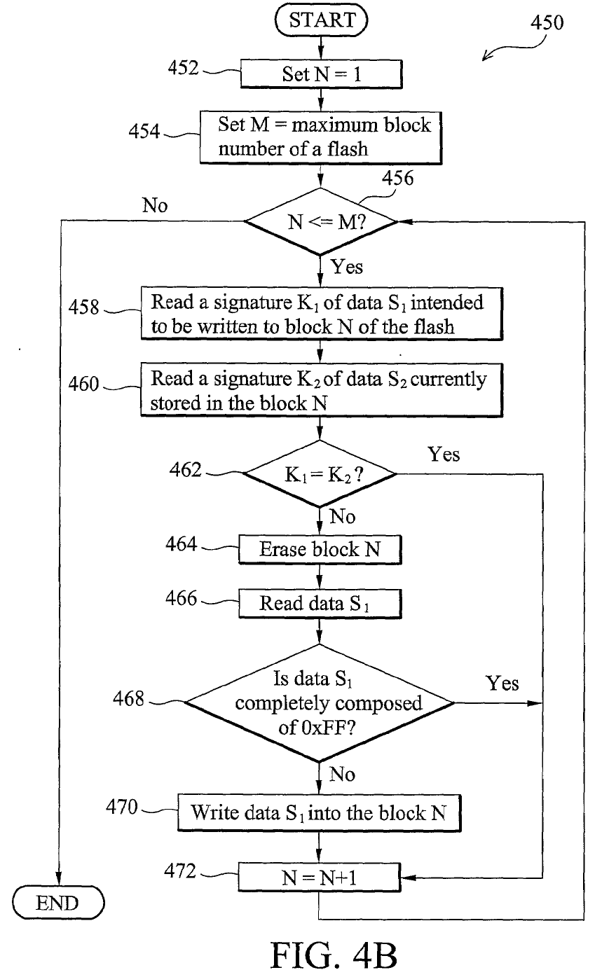

FIG. 4A shows the method 300 combined with the method 200 of FIG. 2A for updating firmware. FIG. 4A is a flowchart of a method 400 for updating a firmware stored in a memory according to the invention. The method 400 is similar to the method 200 with the exception of steps 418 and 420. If a data block S₁ of a new image version is different from a data block S₂ stored in a target block of the memory in step 412, a controller erases the target block in step 414. The controller then detects whether the data block S₁ is completely composed of “0xFF” in step 418. If not, the controller writes the data block S1 into the target block in step 420. Otherwise, the controller skips writing the target block, and the update time is further reduced.

FIG. 4B shows the method 300 combined with the method 250 of FIG. 2B for updating firmware. FIG. 4B is a flowchart of a method 450 for updating a firmware stored in a memory according to the invention. Method 450 is similar to method 400 in FIG. 4A with the exception of steps 458, 460, and 462. A controller directly reads a signature K₁ of a data block S₁ to update the firmware in step 458. The controller also directly reads a signature K₂ of a data block S₂ stored in the target block of the memory in step 460. Because a signature comprises only a few bits, reading signatures in steps 458 and 460 of method 450 requires less time than reading entire data blocks in steps 408 and 410 of method 400. When the controller wants to determine whether data block S₁ stored in the target block is different from a corresponding data block S₂ of a new image version, instead of comparing the entire blocks S₁ and S₂, the controller merely compares the signature K₁ with the signature K₂ in step 462. Thus, the time required by the method 450 for firmware update is further reduced in comparison with the method 400 of FIG. 4A.

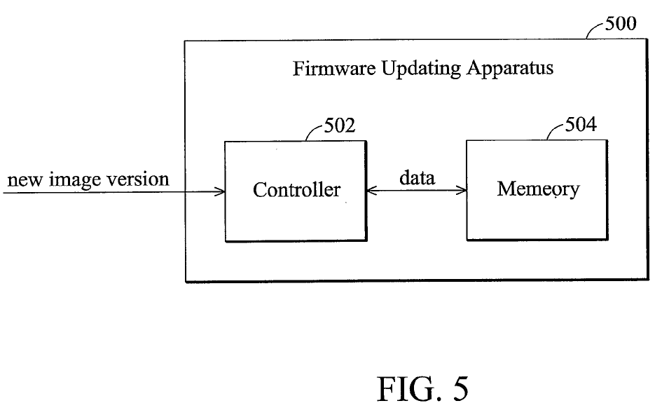

FIG. 5 is a block diagram of a firmware updating apparatus 500 according to the invention. The firmware updating apparatus 500 comprises a memory 504 divided into a plurality of blocks and a controller 502 coupled to the memory 504. The memory 504 stores firmware to be updated with a new image version. The controller 502 controls the updating processs of the formeare stored in the memory 504 and updates only the blocks storing data different from a corresponding data portion of the new image version.

In one embodiment, the controller 502 performs the method 200 to update the firmware stored in the memory 504 and directly compares corresponding data blocks of the new image version and the firmware to be updated to determine whether the corresponding data blocks are the same. The controller 502 reads the new image version to obtain a first data block S1 (step 208), reads a target block selected from the blocks of the memory 504 to obtain a second data block S2 (step 210), determines whether the first data block S1 is different from the second data block S2 (step 212), and writes the first data block S1 into the target block of the memory 504 when the first data block S1 is different from the second data block S2 (step 216).

In one embodiment, the controller 502 also combines the method 200 with the method 400 to update the firmware stored in the memory 504. Thus, when the controller 502 writes the first data block S1 into the target block, the controller 502 erases the target block of the memory 504 (step 414), determines whether the first data block S1 is completely composed of the hexadecimal digits “0xFF” (step 418), and writes the first data block S1 into the target block of the memory 504 when the first data block S1 is not completely composed of “0xFF” (step 420).

In another embodiment, the controller 502 performs the method 250 to update the firmware stored in the memory 504 and compares signatures of corresponding data blocks of the new image version and the firmware to be updated to determine whether the corresponding data blocks are the same, wherein the signatures characterizes the data blocks. The controller 502 reads a first signature K1 of a first data block S1 from the new image version (step 258), reads a second signature K2 of a second data block S2 stored in a target block selected from the blocks (step 260), determines whether the second signature K2 is different from the first signature K1 (step 262), and writes the first data block S1 into the target block of the memory 504 when the first signature K1 is different from the second signature K2 (step 266).

In one embodiment, the controller 502 also combines the method 250 with the method 450 to update the firmware stored in the memory 504. Thus, when the controller 502 writes the first data block S1 into the target block, the controller 502 erases the target block of the memory 504 (step 464), reads the first data block S1 from the new image version (step 466), determines whether the first data block S1 is completely composed of the hexadecimal digits “0xFF” (step 468), and writes the first data block S1 into the target block of the memory 504 when the first data block S1 is not completely composed of “0xFF” (step 470).

In another embodiment, the controller 502 performs the method 300 to update the firmware stored in the memory 504 and erases the memory 504 by checking whether a corresponding data portion is completely composed of the hexadecimal digits “0xFF”. Thus, the controller 502 erases a target block selected from the blocks of the memory 504 (step 308), reads the new image version to obtain a data block S1 for updating the target block (step 310), determines whether the data block S1 is completely composed of the hexadecimal digits “0xFF” (step 312), and writes the data block S1 into the target block when the data block comprises hexadecimal digits different from “0xFF” (step 314).

The invention provides a method for updating firmware stored in a memory. The old content stored in each block of the memory is compared with the corresponding new update data. If the corresponding new data is identical to the old content, no update is required, and the new data is not written into the block. Because firmware changes only slightly, the method greatly reduces the amount of time required by the update process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for updating firmware stored in a memory, wherein the memory is divided into a plurality of blocks, and the firmware to be updated with a new image version, the method comprising:
(a) obtaining a first data block from the new image version, and obtaining a second data block from a target block selected from the memory;
(b) checking whether the first data block is different from the second data block;
(c) writing the first data block into the target block when the first data block is different from the second data block; and
(d) repeating steps (a) to (c) until all of the blocks are processed.

2. The method as claimed in claim 1, wherein when the first data block is identical to the second data block in the step (b), the step (d) is directly performed.

3. The method as claimed in claim 1, wherein the step (c) comprises:
(c1) erasing the target block;
(c2) checking whether the first data block is completely composed of the hexadecimal digits “0xFF”; and
(c3) writing the first data block into the target block when the first data block is not completely composed of the hexadecimal digits “0xFF”.

4. A method for updating firmware stored in a memory, wherein the memory is divided into a plurality of blocks, and the firmware to be updated with a new image version, the method comprising:
(a) obtaining a first signature of a first data block from the new image version, and obtaining a second signature of a second data block from a target block selected from the memory, wherein the first signature characterizes the first data block and the second signature characterizes the second data block;
(b) checking whether the second signature is different from the first signature;
(c) writing the first data block into the target block when the first signature is different from the second signature; and
(d) repeating steps (a) to (c) until all of the blocks are processed.

5. The method as claimed in claim 4, wherein when the first signature is identical to the second signature in the step (b), the step (d) is directly performed.

6. The method as claimed in claim 4, wherein the first signature is a checksum of the first data block and the second signature is a checksum of the second data block.

7. The method as claimed in claim 4, wherein the first signature is a version serial number of the first data block and the second signature is a version serial number of the second data block and.

8. The method as claimed in claim 4, wherein the step (c) comprises:
(c1) erasing the target block;
(c2) checking whether the first data block is completely composed of the hexadecimal digits “0xFF”; and
(c3) writing the first data block into the target block when the first data block is not completely composed of “0xFF”.

9. A method for updating firmware stored in a memory, wherein the memory is divided into a plurality of blocks, and the firmware to be updated with a new image version, the method comprising:
(a) erasing a target block selected from the blocks;
(b) obtaining a data block from the new image version for updating the target block;
(c) checking whether the data block is completely composed of the hexadecimal digits “0xFF”;
(d) writing the data block into the target block when the data block comprises hexadecimal digits different from “0xFF”; and
(e) repeating steps (a) to (d) until all of the blocks are processed.

10. The method as claimed in claim 9, wherein when the first data block is completely composed of the hexadecimal digits “0xFF” in step (c), the step (e) is directly performed.

11. A firmware updating apparatus, comprising:
a memory, divided into a plurality of blocks, storing firmware to be updated with a new image version; and
a controller, coupled to the memory, updating only the blocks storing data different from a corresponding data portion of the new image version.

12. The firmware updating apparatus as claimed in claim 11, wherein the controller reads the new image version to obtain a first data block, reads a target block selected from the blocks to obtain a second data block, determines whether the first data block is different from the second data block, and writes the first data block into the target block when the first data block is different from the second data block.

13. The firmware updating apparatus as claimed in claim 12, wherein when the controller writes the first data block into the target block, the controller erases the target block of the memory, determines whether the first data block is completely composed of the hexadecimal digits “0xFF”, and writes the first data block into the target block when the first data block is not completely composed of “0xFF”.

14. The firmware updating apparatus as claimed in claim 11, wherein the controller reads a first signature of a first data block from the new image version, reads a second signature of a second data block stored in a target block selected from the blocks, determines whether the second signature is different from the first signature, and writes the first data block into the target block of the memory when the first signature is different from the second signature, wherein the second signature characterizes the second data block, and the first signature characterizes the first data block.

15. The firmware updating apparatus as claimed in claim 14, wherein the controller does not write the first data block into the target block when the first signature is identical to the second signature.

16. The firmware updating apparatus as claimed in claim 14, wherein the first signature is a checksum of the first data block and the second signature is a checksum of the second data block.

17. The firmware updating apparatus as claimed in claim 14, wherein the first signature is a version serial number of the first data block and the second signature is a version serial number of the second data block.

18. The firmware updating apparatus as claimed in claim 14, wherein when the controller writes the first data block into the target block, the controller erases the target block of the memory, reads the first data block from the new image version, determines whether the first data block is completely composed of the hexadecimal digits “0xFF”, and writes the first data block into the target block when the first data block is not completely composed of“0xFF”.

19. A firmware updating apparatus, comprising:
a memory, divided into a plurality of blocks, storing firmware to be updated with a new image version; and
a controller, coupled to the memory, erasing the memory by checking whether a corresponding data portion is completely composed of the hexadecimal digits “0xFF”.

20. The firmware updating apparatus as claimed in claim 19, wherein the controller erases a target block selected from the blocks, reads the new image version to obtain a data block for updating the target block, determines whether the data block is completely composed of the hexadecimal digits “0xFF”, and writes the data block into the target block when the data block comprises hexadecimal digits different from “0xFF”.
